(19) United States
(12) Patent Application Publication
(10) Pub. No.: US 2010/0325316 A1
(43) Pub. Date: Dec. 23, 2010

(54) ADMINISTRATION DEVICE

(75) Inventor: Kan Ishimoto, Nagoya-shi (JP)

Correspondence Address: Scully, Scott, Murphy & Presser, P.C., 400 Garden City Plaza, Suite 300, Garden City, NY, 11530, US

(73) Assignee: BROTHER KOGYO KABUSHIKI KAISHA, Aichi-ken (JP)

(21) Appl. No.: 12/726,753

(22) Filed: Mar. 18, 2010

(30) Foreign Application Priority Data
Jun. 23, 2009 (JP) 2009-148619

(51) Int. Cl. G06F 3/00

(52) U.S. Cl. 710/19

(57) ABSTRACT

An administration device may be connected in a communicable manner with a plurality of devices including a first device and a second device. The administration device may comprise an information acquisition unit configured to execute an information acquisition process for sequentially acquiring information from the plurality of devices by sequentially making a request for the information to the plurality of devices. The information acquisition unit may make a request for status information to the first device, (a) if the status information of the first device does not indicate, for example, a sleeping status or a process executing status, make a request for target information other than the status information to the first device, and make a request for the status information to the second device after having made the request for the target information to the first device, (b) if the status information of the first device indicates, for example, the sleeping status or the process executing status, make the request for the status information to the second device without making the request for the target information to the first device.

### CROSS-REFERENCE TO RELATED APPLICATIONS

This application claims priority to Japanese Patent Application No. 2009-148619, filed on Jun. 23, 2009, the contents of which are hereby incorporated by reference into the present application.

### TECHNICAL FIELD

The present specification discloses an administration device that acquires information from each of a plurality of devices.

### DESCRIPTION OF THE RELATED ART

An administration device which administers a plurality of devices (e.g. a printer, etc.) connected with a network is known. The administration device periodically executes an information acquisition process for sequentially acquiring target information, e.g., regarding remaining toner, name of print job being executed, etc, from the plurality of devices by sequentially making a request for the target information.

### SUMMARY

The above administration device makes a request for the target information to a specific device regardless of the status of the specific device at the time of requesting the target information. Consequently, the administration device has made the request for the target information to the specific device even though this requesting action was unnecessary. Further, the request for the target information to the specific device was poorly timed, such that the target information could not be acquired quickly from the specific device. Since the status of the specific device was not taken into consideration, it was difficult to acquire information appropriately from the specific device.

In the present specification, an administration device is taught which requests information in accordance with a status of a device.

One aspect of techniques disclosed in the present specification is an administration device to be connected in a communicable manner with a plurality of devices including a first device and a second device. The administration device may comprise an information acquisition unit configured to execute an information acquisition process for sequentially acquiring information from the plurality of devices by sequentially making a request for the information to the plurality of devices.

The information acquisition unit may be configured to make a request for status information to the first device, (a) if the status information of the first device does not indicate a sleeping status, make a request for target information other than the status information to the first device, and make a request for the status information to the second device after having made the request for the target information to the first device, (b) if the status information of the first device indicates the sleeping status, make the request for the status information to the second device without making the request for the target information to the first device.

Alternatively, the information acquisition unit may be configured to make a request for status information to the first device, (a) if the status information of the first device does not indicate a process executing status, make a request for target information other than the status information to the first device, and make a request for the status information to the second device after having made the request for the target information to the first device; and (b) if the status information of the first device indicates the process executing status, make the request for the status information to the second device without making the request for the target information to the first device.

Other aspects of techniques disclosed in the present specification may provide a control method, a computer program for realizing the administration device, and a computer readable medium storing the computer program that are novel and have utility. Further, another aspect of techniques disclosed in the present specification may provide a system including the administration device, the first device, and the second device that is novel and has utility.

### BRIEF DESCRIPTION OF THE DRAWINGS

FIG. 1 shows a configuration of an administration system of a first embodiment. FIG. 2 shows an example of a target information table. FIG. 3 shows a sequence view of processes executed by each device. FIG. 4 shows a flowchart of an information acquisition process. FIG. 5 shows a flowchart of a polling period setting process. FIG. 6 shows a time chart of processes executed by each device. FIG. 7 shows a flowchart of a standby period setting process in a second embodiment.

### DETAILED DESCRIPTION OF THE PREFERRED EMBODIMENT

### First Embodiment

### Configuration of System

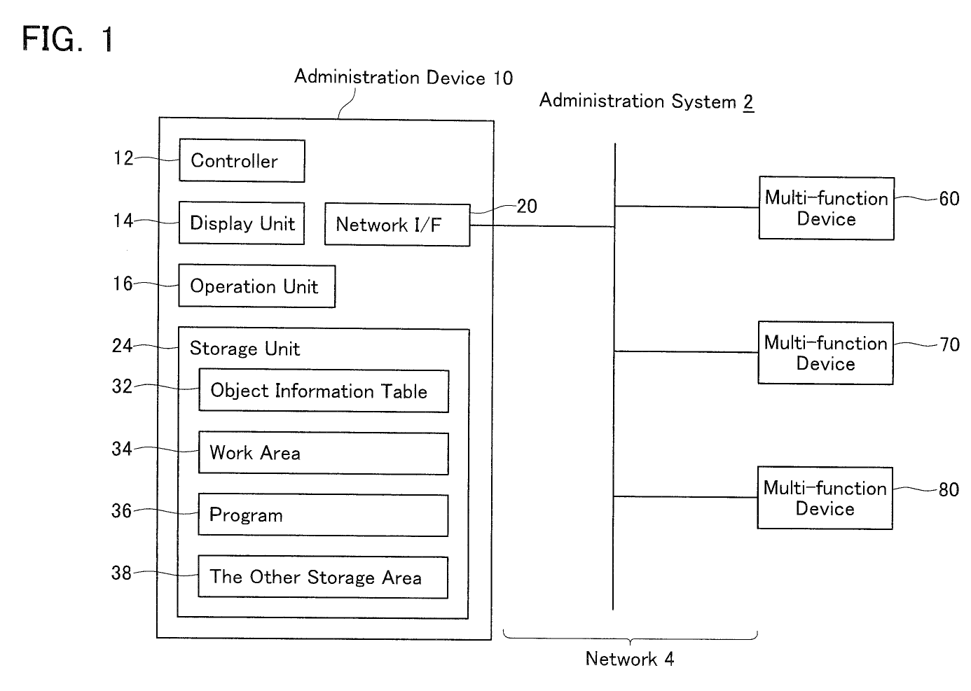

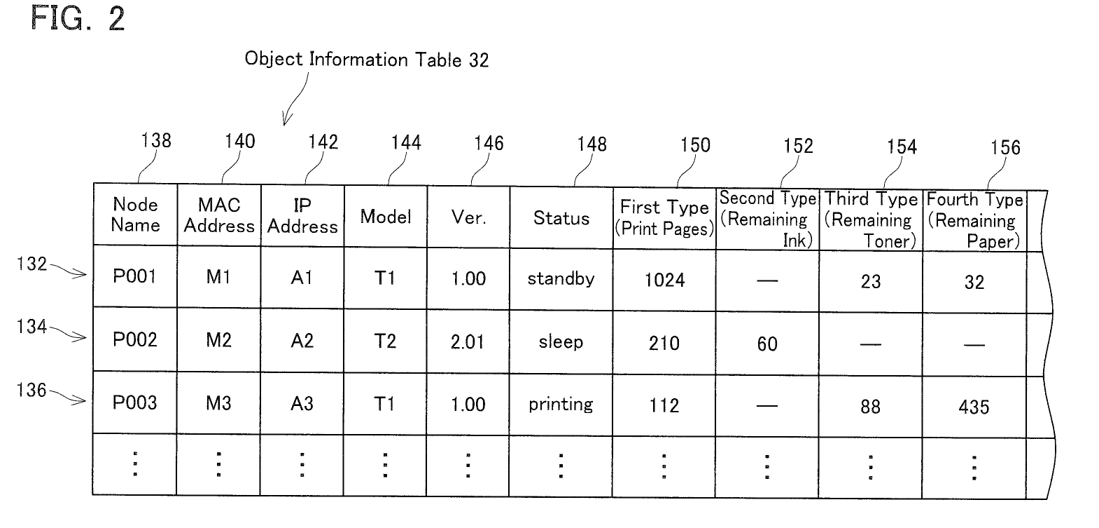

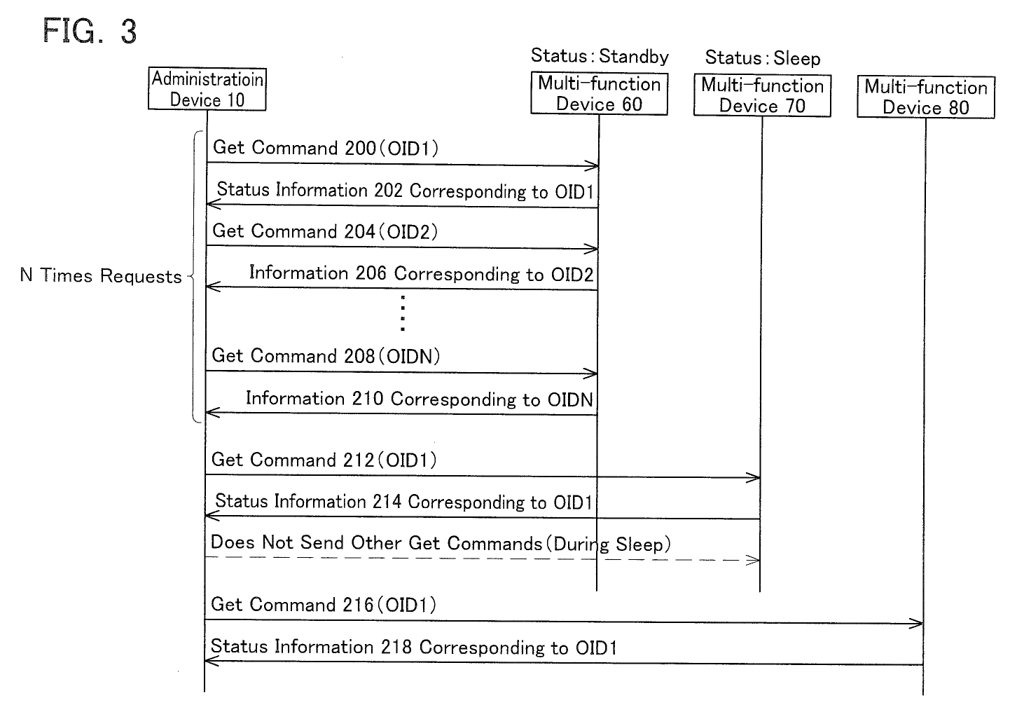

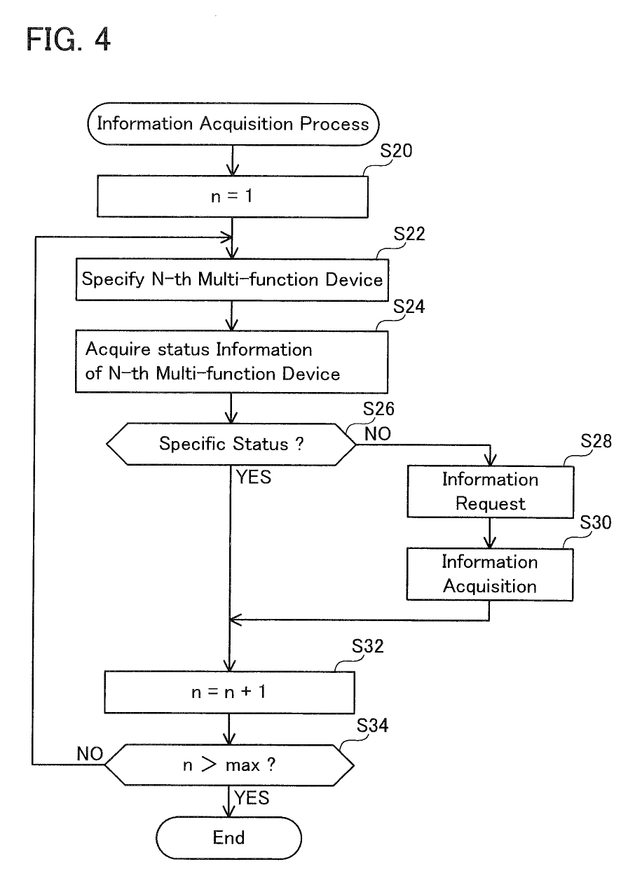

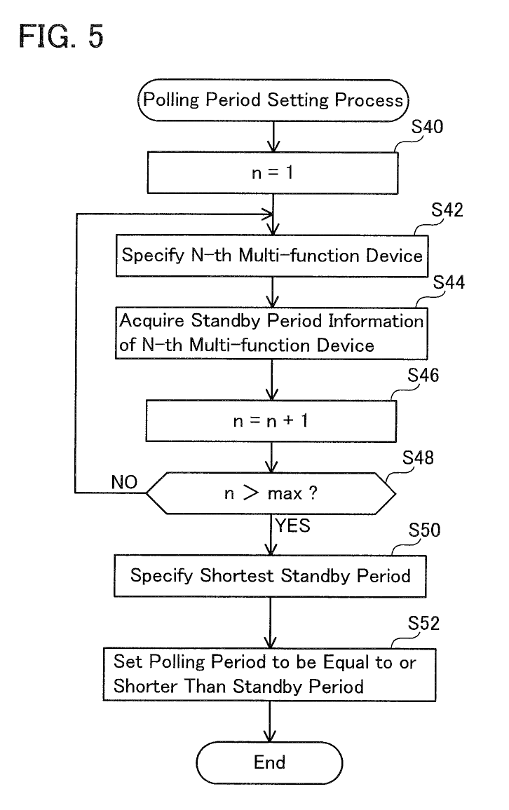

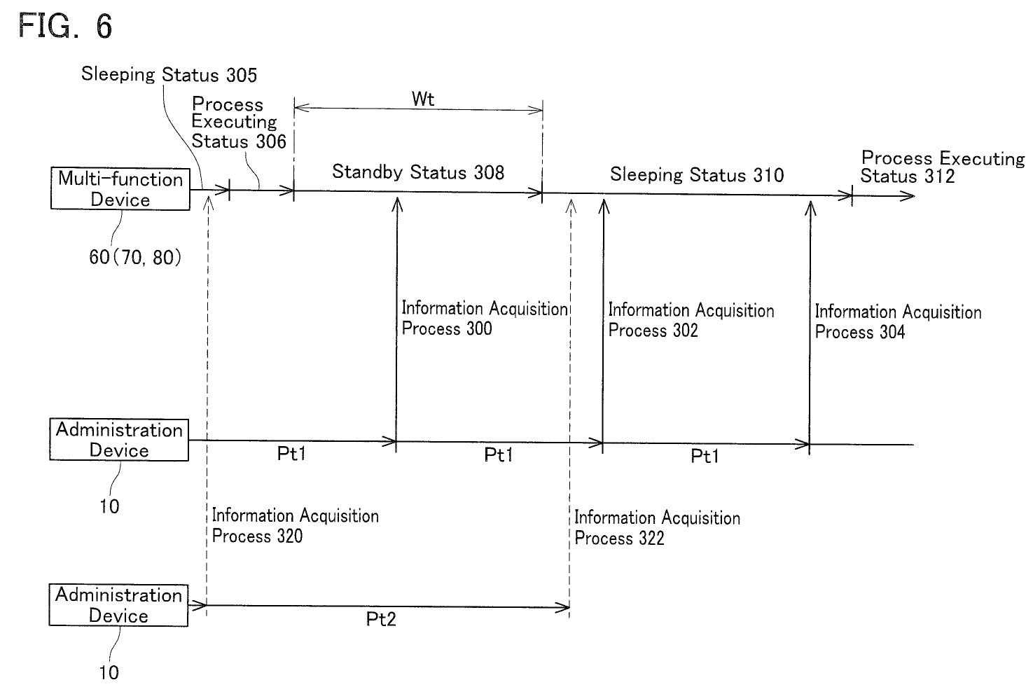

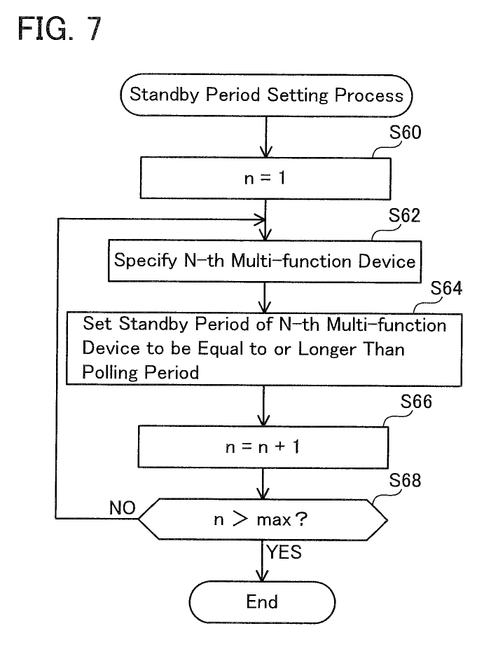

The first embodiment will be explained with reference to FIGS. 1 to 6. An administration system 2 comprises a network 4 including a LAN, etc., an administration device 10, a plurality of multi-function devices 60, 70, 80, etc. The devices 10, 60, 70, 80 are all connected with the network 4. The devices 10, 60, 70, 80 can communicate with each other via the network 4. The multi-function devices 60, etc. comprise a printing function, scanning function, fax communication function, etc.

(Configuration of the Administration Device)

The configuration of the administration device 10 will be explained in detail. In the present embodiment, an example will be explained using a PC as the administration device 10. The administration device 10 administers the multi-function devices 60, etc. by executing processes to acquire information therefrom.

The administration device 10 comprises a controller 12, display unit 14, operation unit 16, network interface 20, and storage unit 24. The controller 12 executes processes in accordance with a program 36 stored in the storage unit 24. The display unit 14 displays a variety of information. The operation unit 16 comprises a plurality of keys. A user can input various instructions to the administration device 10 by operating the operation unit 16. The network interface 20 is connected with the network 4.

The storage unit 24 stores a target information table 32 (FIG. 2). The storage unit 24 comprises a work area 34. The work area 34 stores information created or acquired by the controller 12 executing processes. The storage unit 24 stores the program 36 to be executed by the controller 12. The program 36 is installed in the storage unit 24 from a computer readable medium which records the program 36 to be executed by the controller 12. Alternatively, the program 36 need not be installed from the computer readable medium, but may be downloaded from an exterior source. The storage unit 24 further has another storage area 38 for storing information other than the information 32, 36 (e.g., information acquisition polling period (described later in detail), etc.).

A target information table 32 exemplified in FIG. 2 includes a plurality of combination information 132 to 136. The combination information 132 to 136 is information in which the following are associated: node name 138, MAC address 140, IP address 142, model information 144, firmware version information 146, status information 148, and a plurality of types of dynamic information 150, 152, 154, 156. The combination information 132, etc. indicates information relating to the multi-function devices 60, etc., which are administered by the administration device 10.

If the combination information 132 is information relating to the multi-function device 60, the multi-function device 60 has node name “P001”, MAC address “M1”, and IP address “A1” included in the combination information 132. Further, the multi-function device 60 is a device with the model information “T1”, and operates in accordance with a firmware having a firmware version information “1.00”. The status information 148 is information indicating status of the multi-function devices 60, etc. The status of the multi-function devices 60, etc. includes a process executing status in which a process is being executed, a standby status (waiting status) in which the multi-function device is on standby and able to execute a process, a sleeping status which has lower power consumption than the standby status (lower power consumption than the process executing status), an error status in which an error has occurred, etc. The process executing status includes various types of status of the multi-function devices 60, etc., such as printing executing status in which printing is executed, scanning status in which scanning is executed, etc. Further, the error status includes various types of status, such as a status in which the toner or ink for printing is empty, or in which the printing paper is out, etc. The error status is a status in which the multi-function devices 60, etc. cannot execute a specific process (printing process, scanning process, etc.).

A plurality of types of dynamic information 150, etc. is information whose value (or quantity) changes as the multi-function devices 60, etc. execute a process. The dynamic information 150, etc. includes e.g., information relating to a number of print pages that is the total number of printed pages, information relating to the quantity of consumable items (remaining ink etc.), etc. If the combination information 132 is information of the multi-function device 60, the multi-function device 60 has “1024” as the first type of dynamic information (print pages). Further, the multi-function device 60 of the present embodiment prints using toner, not ink. Consequently, the multi-function device 60 does not have the second type of dynamic information (regarding remaining ink), but has the third type of dynamic information (regarding remaining toner). The multi-function device 60 cannot respond to a request for the second type of dynamic information which it does not have.

(Outline of Processes Executed by Administration Device and Multi-Function Device)

A brief explanation will be given of the processes executed by the administration device 10 and the multi-function devices 60, etc. FIG. 3 shows a sequence view of the processes executed by the administration device 10 and the multi-function devices 60, 70, 80. In the example of FIG. 3, the status of the multi-function device 60 is standby status, and the status of the multi-function device 70 is sleeping status. The status of the multi-function device 80 is not indicated.

In the present embodiment, the administration device 10 and the multi-function devices 60, 70, 80 communicate in accordance with an SNMP (Simple Network Management Protocol). The administration device 10 is equivalent to an SNMP manager, and the multi-function devices 60, 70, 80 are equivalent to SNMP agents. The administration device 10 requests information by sending a Get command to the multi-function devices 60, 70, 80. This Get command includes an object identifier (termed “OID (Object Identifier)” below) for identifying information.

When an information acquisition polling period has elapsed, the administration device 10 starts an information acquisition process as exemplified in FIG. 3. The administration device 10 requests the status information of the multi-function device 60 by sending a Get command 200 to the multi-function device 60. The Get command 200 includes one OID 1 corresponding to the status information. As a result thereof, the multi-function device 60 sends status information 202 corresponded to the OID 1 to the administration device 10. In the present example, the multi-function device 60 sends status information indicating standby status to the administration device 10. In the case where the status information of the multi-function device that is a destination of the status information request is none of sleeping status, process executing status, and error status, the administration device 10 makea a request for information (target information) whose purpose is other than the status information to the multi-function device. Consequently, the administration device 10 sends a Get command 204 including one OID 2 corresponding to information (e.g. print pages) other than the status information to the multi-function device 60. If the multi-function device 60 has information 206 corresponding to the OID 2 (if the multi-function device 60 can respond), the multi-function device 60 sends the information 206 to the administration device 10. Although not shown in FIG. 3, if the multi-function device 60 does not have the information 206 corresponding to the OID 2 (if the multi-function device 60 cannot respond), the multi-function device 60 sends a response indicating it cannot respond to the administration device 10 (alternatively, it may not send a response to the administration device 10). Next, the administration device 10 requests one other type of information (e.g. remaining ink) by sending a Get command to the multi-function device 60. If N types of information that the administration device 10 can request are present (N being an integer of two or more), the administration device 10 sequentially sends N number of Get commands 200, 204, 208, etc. to the multi-function device 60 and acquires, from the multi-function device 60, the information 202, 206, 210, etc. for which the multi-function device 60 is capable of responding.

The method for the administration device 10 to acquire information from the multi-function device 60 is not restricted to sending a Get command including one OID repeatedly over N times to the multi-function device 60, as in the above example. Aside from the status information, if the administration device 10 knows other types of information for which the multi-function device 60 is capable of responding, a Get command including all OIDs corresponding to those types of information may be sent at once to the multi-function device 60, and the information of the aforesaid other types may be acquired altogether.

After acquiring the status information 202 and other target information 206, 210, etc. from the multi-function device 60, the administration device 10 sends a Get command 212 including one OID 1 corresponding to the status information to the multi-function device 70. The multi-function device 70 sends status information 214 corresponded to the OID 1 to the administration device 10. In the present example, the status information of the multi-function device 70 is sleeping status. In the case where the status information of the multi-function device that is a destination of the status information request is one of sleeping status, process executing status, and error status, the administration device 10 does not make a request for information other than the status information to that multi-function device. Consequently, the administration device 10 does not send a Get command requesting information whose purpose is other than the status information to the multi-function device 70. Next, the administration device 10 sends a Get command 216 including one OID 1 corresponding to status information to the multi-function device 80. The multi-function device 80 sends status information 218 corresponded to the OID 1 to the administration device 10. As in the case of the multi-function devices 60, 70, the administration device 10 determines whether to further make a request for information other than the status information to the multi-function device 80 based on the status information 218 of the multi-function device 80.

(Process Executed by the Administration Device 10)

Next, the contents of a process executed by the controller 12 of the administration device 10 will be explained with reference to FIG. 4. When a power source of the administration device 10 is turned ON, the controller 12 monitors the progress of the information acquisition polling period. If the information acquisition polling period has elapsed, the controller 12 starts the information acquisition process. In the information acquisition process, the controller 12 acquires the IP addresses of the plurality of multi-function devices 60, etc. connected with the network 4 by broadcasting a predetermined command (not shown). First, the controller 12 sets n=1 (S20). Next, the controller 12 specifies the IP address of the n-th multi-function device from the IP addresses of the plurality of multi-function devices 60, etc. (S22). The controller 12 makes a request for the status information to the n-th multi-function device by sending a Get command to the IP address of the n-th multi-function device. Consequently, the controller 12 acquires the status information from the n-th multi-function device (S24). Upon acquiring the status information, the controller 12 determines whether the acquired status information is a specific status (S26). The specific status includes the sleeping status, process executing status, and error status. If the answer is YES in S26, the controller 12 continues to S32 without making a request for further information to the n-th multi-function device.

If the answer is NO in S26, the controller 12 sequentially sends, to the n-th multi-function device, Get commands including OIDs corresponding to a variety of information other than the status information (S28). The n-th multi-function device sends information for which it is capable of responding to the administration device 10. Consequently, the administration device 10 acquires the information (S30). The acquired information includes the dynamic information 150 to 156 shown in FIG. 2. Upon ending S30, the controller 12 continues to S32.

In S32, the controller 12 increments the number n by one, and determines n+1 to be the new n. When the new n has been determined, the controller 12 determines whether the new n is greater than the total (maximum) number of the IP addresses of the plurality of multi-function devices 60, etc. acquired by the aforementioned broadcast (S34). If the answer is NO in S34, the controller 12 returns to S22, specifies the newly specified n-th device, and repeats the processes S22 to S34. If the answer is YES in S34, the controller 12 ends the information acquisition process.

As described above, the information acquisition process of FIG. 4 is executed each time the information acquisition polling period elapses. The contents of a process for the controller 12 to set the information acquisition polling period will be explained with reference to FIG. 5. The polling period setting process is executed e.g., each time the power source of the administration device 10 is turned ON. However, the polling period setting process may be executed, e.g., in accordance with an instruction from the user. As with the information acquisition process, the controller 12 acquires the IP addresses of the plurality of multi-function devices 60, etc. by broadcasting a predetermined command. The controller 12 sets n=1 (S40), and specifies the IP address of the n-th multi-function device (S42). Next, the controller 12 sends, to the IP address of the n-th multi-function device, a Get command including an OID corresponding to standby period information. The standby period information is information related to a standby period after the process executing status is finished to when the n-th multi-function device transits to the sleeping status via the standby status. The n-th multi-function device sends the standby period information to the administration device 10. Consequently, the controller 12 acquires the standby period information (S44). S46 and S48 executed after S44 are identical to S32 and S34 of FIG. 4.

If the answer is YES in S48, the controller 12 specifies the shortest standby period from the standby period information of the multi-function devices 60, etc. acquired in S44 (S50). Next, the controller 12 sets polling period for acquiring the information from the multi-function devices 60, etc. to be a specific value equal to or less than (shoter than) the specified standby period (S52). The controller 12 stores the specific value (i.e., polling period) in the storage area 38 (see FIG. 1). Later, the controller 12 monitors that the polling period stored in the storage area 38 has elapsed, and executes the information acquisition process of FIG. 4 each time the polling period has elapsed.

As shown in FIG. 6, upon receiving a process executing instruction (e.g. printing instruction, scanning instruction, information displaying instruction, etc.) during a sleeping status 305, the multi-function device 60 transits to a process executing status 306. Upon ending the process executing status 306, the multi-function device 60 transits to a standby status 308. If, after transiting to the standby status 308, a predetermined time period (Wt) continues during which the process executing instruction is not received, the multi-function device 60 transits to a sleeping status 310. Although not shown, if the process executing instruction is received during the standby status 308, the multi-function device 60 transits back to a process executing status. The sleeping status 310 continues until the process executing instruction is received. Upon receiving the process executing instruction during the sleeping status 310, the multi-function device 60 transits to a process executing status 312.

Each time the polling period (Pt1) set in S52 of FIG. 5 has elapsed, the administration device 10 executes the information acquisition processes 300, 302, 304 shown in FIG. 4 for the multi-function device 60. In the present embodiment, the polling period (Pt1) and the standby period (Wt) of the multi-function device 60 are set by the polling period setting process shown in FIG. 5 to satisfy the relationship Pt1≦Wt. The standby period of the other multi-function devices 70, etc. is also equal to or more than (longer than) the polling period (Pt1).

The case where the polling period has been set to Pt2 shown in FIG. 6 will now be considered. This polling period (Pt2) is set to be longer than the standby period (Wt) (Pt2>Wt). The administration device 10 executes the information acquisition processes 320, 322 for the multi-function device 60 each time the information acquisition polling period (Pt2) has elapsed. In this case, the multi-function device 60 is in the sleeping statuses 305, 310 at both occasions when the administration device 10 executes the information acquisition processes 320, 322. However, during the polling period (Pt2), the multi-function device 60 transits from the sleeping status 305 to the process executing status 306, then transits back to the sleeping status 310 via the standby status 308. In the process executing status 306, it is likely that the dynamic information (e.g. print pages, remaining toner, etc.) of the multi-function device 60 will change. Nevertheless, the administration device 10 cannot acquire, in the information acquisition process 322, the dynamic information that has changed during the process executing status 306.

To deal with this, in the present embodiment, the information acquisition polling period (Pt1) has been set to be equal to or shorter than the standby period (Wt). Consequently, during two successive information acquisition processes, the situation does not occur, of the multi-function device 60 transiting from the sleeping status to the process executing status, and then transiting back to the sleeping status via the standby status. Consequently, the administration device 10 can reliably acquire, in the information acquisition process 300, the dynamic information that has changed during the process executing status 306.

The administration device 10 of the present embodiment has been explained in detail above. In the administration device 10 of the present embodiment, as shown in FIG. 3, the administration device 10 makes the request for the information other than the status information to the multi-function device 60 in the case where the status of the multi-function device 60 is in none of the specific statuses (i.e., the sleeping status, process executing status, and error status). Further, in the case where the status of the multi-function device 70 is in the specific status, the administration device 10 proceeds to make the request for the status information to the other multi-function device 80 without further making the request for the information other than the status information to the multi-function device 70. If the status of the multi-function device 70 is in the sleeping status, it is likely that the dynamic information of the multi-function device 70 has not changed from that acquired by the previous request. Further, if the multi-function device 70 is in the error status, also, it is likely that the dynamic information of the multi-function device 70 has not changed from that acquired by the previous request. According to the present embodiment, unnecessary request of unchanged dynamic information to the multi-function device 70 can be prevented. Further, if the multi-function device 70 is in the process executing status (having a high processing load), it is likely that a long period is needed to respond to the request. It is possible to prevent sending a request to the multi-function device 70 that is likely to need a long period of time before responding. The administration device 10 of the present embodiment can request information in accordance with the status of the multi-function devices 60, 70, 80.

### Second Embodiment

The second embodiment will be explained with reference to FIG. 7. In the first embodiment, as shown in FIG. 5, the administration device 10 sets its information acquisition polling period according to the standby period of the multi-function devices 60, etc. By contrast, in the present embodiment, the information acquisition polling period of the administration device 10 is fixed, and the administration device 10 sets the standby period of the multi-function devices 60, etc. according to its own information acquisition polling period. Moreover, the information acquisition polling period may be a default value, or may be a value set by the user.

As shown in FIG. 7, the standby period setting process is executed, e.g., each time the power source of the administration device 10 is turned ON. However, the standby period setting process may, e.g., be executed in accordance with an instruction from the user. The processes S60 and S62 are identical to the processes S20 and S22 of FIG. 4. In S64, the controller 12 determines a specific value equal to or more than (longer than) the fixed information acquisition polling period. Next, the controller 12 sets the standby period of the n-th multi-function device to the determined specific value. Specifically, the controller 12 sends, to the n-th multi-function device, a Set command including the specific value and an OID corresponding to the standby period. S66 and S68 executed after S64 are identical to S32 and S34 of FIG. 4.

According to the administration device 10 of the present embodiment, as shown in S62 to S68 (FIG. 7), the standby period of the multi-function devices 60, etc. is set to be equal to or longer than the polling period of the administration device 10. Consequently, as with the case of the first embodiment, if the dynamic information of the multi-function devices 60, etc. has changed, the administration device 10 can reliably acquire the changed dynamic information.

As is clear from the above explanation, the multi-function devices 60, 70, 80 are examples of “a plurality of devices”. The information whose purpose is other than status information is an example of “target information”. The polling period (Pt1) is an example of “predetermined time cycle”. The information acquisition process of FIG. 4, the processes S40 to S48 of FIG. 5, the processes S50 and S52 of FIG. 5, and the standby period setting process of FIG. 7 are each an example of processes executed by “information acquisition unit”, “standby period information acquisition unit”, “time cycle setting unit”, and “standby period setting unit”, respectively.

Variants of the above embodiments are given below. In the embodiments, an example was explained wherein the sleeping status, process executing status, and error status illustrate the specific status, and information other than the status information is requested to the multi-function devices 60, etc. if none of these states are applicable. However, the specific status is not restricted to these three statuses. E.g., the specific status may be only one or two from among the sleeping status, process executing status, and error status.

In the embodiments, the administration device 10 was explained that is capable of executing only one of the polling period setting process (first embodiment) and the standby period setting process (second embodiment). However, the administration device 10 may be capable of executing both the polling period setting process and the standby period setting process. In that case, the user may be capable of selecting one mode from among a mode for executing the polling period setting process and a mode for executing the standby period setting process.

Generally speaking, the administration device may allow a user to select one mode among a first mode wherein the time cycle setting unit sets the predetermined time cycle, and a second mode wherein the standby period setting unit sets the standby period of the plurality of devices to the predetermined time period.

Furtheremore, the information other than the status information may include information (for example, Node name, MAC address, Model name, etc) which is not changed as the multi-function devices 60, etc. execute processes. That is, the information other than the status information may be the dynamic information, and may not be the dynamic information.

What is claimed is:

1. An administration device configured to be connected in a communicable manner with a plurality of devices including a first device and a second device, the administration device comprising:
an information acquisition unit configured to execute an information acquisition process for sequentially acquiring information from the plurality of devices by sequentially making a request for the information to the plurality of devices, wherein
the information acquisition unit is configured to:
make a request for status information to the first device;
(a) if the status information of the first device does not indicate a sleeping status, make a request for target information other than the status information to the first device, and make a request for the status information to the second device after having made the request for the target information to the first device; and
(b) if the status information of the first device indicates the sleeping status, make the request for the status information to the second device without making the request for the target information to the first device.

2. The administration device as in claim 1, wherein
(a′) if the status information of the first device does not indicate the sleeping status and the status information of the first device does not indicate a process executing status, the information acquisition unit makes the request for the target information to the first device, and make the request for the status information to the second device after having made the request for the target information to the first device.

3. The administration device as in claim 1, wherein
the target information includes information which is changed as the first device executes a process.

4. The administration device as in claim 1, further comprising:
a standby period information acquisition unit; and
a time cycle setting unit,
wherein the information acquisition unit executes the information acquisition process periodically in a predetermined time cycle,
the standby period information acquisition unit acquires, from each of the plurality of devices, information related to a standby period, wherein the standby period of each of the plurality of devices is a time period from a time that a process executing status is finished until transiting to the sleeping status via a standby status, and
the time cycle setting unit sets the predetermined time cycle to be equal to or shorter than the shortest one of a plurality of standby periods of the plurality of devices.

5. The administration device as in claim 1, further comprising:
a standby period setting unit configured to send, to the plurality of devices, a setting instruction for setting a standby period to a predetermined time period, wherein the standby period is a time period from a time that a process executing status is finished until transiting to the sleeping status via a standby status,
wherein the information acquisition unit executes the information acquisition process periodically in a predetermined time cycle that is equal to or longer than the predetermined time period.

6. An administration device configured to be connected in a communicable manner with a plurality of devices including a first device and a second device, the administration device comprising:
an information acquisition unit configured to execute an information acquisition process for sequentially acquiring information from the plurality of devices by sequentially making a request for the information to the plurality of devices, wherein
the information acquisition unit is configured to:
make a request for status information to the first device;
(a) if the status information of the first device does not indicate a process executing status, make a request for target information other than the status information to the first device, and make a request for the status information to the second device after having made the request for the target information to the first device; and
(b) if the status information of the first device indicates the process executing status, make the request for the status information to the second device without making the request for the target information to the first device.

7. The administration device as in claim 6, wherein
(a′) if the status information of the first device does not indicate the process executing status and the status information of the first device does not indicate a sleeping status, the information acquisition unit makes the request for the target information to the first device, and make the request for the status information to the second device after having made the request for the target information to the first device.

8. The administration device as in claim 6, wherein
the first device comprises a printing function, and
the process executing status includes a print executing status.

9. A computer readable medium including a computer program for an administration device configured to be connected in a communicable manner with a plurality of devices including a first device and a second device,
the computer program including instructions for ordering a computer mounted on the administration device to execute:
an information acquisition process for sequentially acquiring information from the plurality of devices by sequentially making a request for the information to the plurality of devices,
wherein the information acquisition process includes:
making a request for status information to the first device;
(a) if the status information of the first device does not indicate a sleeping status, making a request for target information other than the status information to the first device, and making a request for the status information to the second device after having made the request for the target information to the first device; and
(b) if the status information of the first device indicates the sleeping status, making the request for the status information to the second device without making the request for the target information to the first device.

10. A computer readable medium including a computer program for an administration device configured to be connected in a communicable manner with a plurality of devices including a first device and a second device,
the computer program including instructions for ordering a computer mounted on the administration device to execute:
an information acquisition process for sequentially acquiring information from the plurality of devices by sequentially making a request for the information to the plurality of devices,
wherein the information acquisition process includes:
making a request for status information to the first device;
(a) if the status information of the first device does not indicate a process executing status, making a request for target information other than the status information to the first device, and making a request for the status information to the second device after having made the request for the target information to the first device; and
(b) if the status information of the first device indicates the process executing status, making the request for the status information to the second device without making the request for the target information to the first device.
